(19) United States
(12) Patent Application Publication
(10) Pub. No.: US 2003/0032903 A1
(43) Pub. Date: Feb. 13, 2003

(54) Method of controlling massaging machine

(75) Inventor: Eiji Kasai, Kyoto (JP)

Correspondence Address: BEYER WEAVER & THOMAS LLP, P.O. BOX 778, BERKELEY, CA, 94704-0778, US

(73) Assignee: OMRON Corporation

(21) Appl. No.: 10/186,955

(22) Filed: Jun. 27, 2002

(30) Foreign Application Priority Data
Jul. 31, 2001 (JP) 2001-232683

(51) Int. Cl. A61H 15/00

(52) U.S. Cl. 601/99; 601/100; 601/103; 601/116

(57) ABSTRACT

In operating a massaging machine having massaging members and a motor for causing the massaging members to vibrate to massage a patient, a pulsed driving signal is applied to the motor for repetitively switching on and off the motor for specified time lengths such that the motor is intermittently activated, rather than continuously.

### BACKGROUND OF THE INVENTION

This invention relates to a method of controlling a massaging machine.

Physical stimuli to a human body have been classified into the following six types: stroking, kneading, pushing, vibrating, pulling and patting. These stimuli are communicated to a body surface or hypodermic soft tissues to directly stimulate the peripheral nerves so as to relax the body tension. Indirectly, they accelerate the recovery of functions of the body as a whole, thereby improving the natural healing power of the body and the natural tendency to maintain the body in a natural condition. It has been expected that such massaging stimuli have therapeutic effects.

Such stimuli used to be delivered manually, that is, by massaging. Recently, massaging machines having similar effects on the human body by means of mechanical actions are being developed.

The body contacting portion of a massaging operation is performed in different manners. The masseur may form a fist and pat the body on the side of the little finger. The strength of operation can be controlled by forming the fist tightly or lightly. The masseur may open the operating hand with all fingers stretched and pat the patient's body repeatedly on the side of the little finger so as to provide small vibrations to the body. The masseur may further clasp both hands and pat the patient's body with fingers separated so as to deliver elastic forces. Various methods of reproducing these effects mechanically have been tried and incorporated into a massaging machine in the form of a chair.

One of conventional kinds of massaging machine was comprised of a structure dedicated to a patting operation, driven by a dedicated driving circuit. Another kind included contact members to carry out a repetitive patting action. If a structure dedicated to a patting action is used, the patient can enjoy the feeling of being massaged by a live masseur but the machine tends to become noisy. If it is combined with another kind of massaging machine, it becomes too expensive to be feasible. The method of using contact members is advantageous because they can be operated by adding a simple mechanism for tapping operation and a simple program but the patient does not necessarily receive the same feeling of being treated by a live masseur because the oscillatory stimuli are delivered too continuously.

Massaging machines would be more highly valued if they were capable of delivering to the patient the feeling of being massaged by the fist or clasped hands of a masseur, but it has been a difficult proposal.

### SUMMARY OF THE INVENTION

It is therefore an object of this invention to provide a method of controlling a massaging machine such that the sensation given to the patient will be closer to that given by a live masseur.

By a method according to this invention, the motor of which the rotary motion is transmitted to massaging members of a massaging machine is adapted to receive a driving signal which repeats switching on and off the motor such that the motor is operated intermittently.

The massaging members are provided for kneading and stretching back muscles. The present invention makes effective use of such massaging members, their control mechanism and their control circuit such that the patient will have a sensation close to that received from a live masseur. Explained more in detail, the same mechanism for causing its massaging members to carry out the continuous oscillatory operation by applying a constant voltage is used but a pulsed voltage is inputted according to this invention such that the motor is switched on and off at specified intervals and is operated intermittently and that the massaging members can provide a more pleasant sensation to the patient.

### BRIEF DESCRIPTION OF THE DRAWINGS

FIG. 1 is a diagonal external view of a massaging machine which may employ a method of control embodying this invention.

FIG. 2 is a side view of the massaging machine of FIG. 1.

FIG. 3 is a front view of the therapy unit.

FIG. 4 is a right-hand side view of the therapy unit.

FIG. 5 is a back view of the therapy unit.

FIG. 6 is a diagonal frontal view of the therapy unit.

FIG. 7 is a diagonal back view of the therapy unit.

FIG. 8 is a front view of the treatment part.

FIG. 9 is a back view of the treatment part.

FIG. 10 is a diagonal back view of the treatment part taken from an upward position.

FIG. 11 is a frontal view of the treatment part taken from its right-hand side.

FIG. 12 is a diagonal frontal view of the treatment part taken from the left-hand side.

FIG. 13 is a diagonal back view of the treatment part taken from a lower position.

FIGS. 14 and 15 are back views of the kneading mechanism with some components removed for clarity.

FIG. 16 is a drawing for showing the structure of the patting mechanism.

FIG. 17 is a waveform diagram of an ordinary voltage applied to a massaging machine.

FIG. 18 is a waveform of pressure felt by a patient when the massaging machine is operated according to FIG. 18.

FIG. 19 is a waveform of stimuli to a patient when massaged by a live masseur.

FIG. 20 is an example of waveform of the voltage applied according to this invention to a massaging machine.

FIG. 21 is a waveform of stimuli by massaging according to this invention.

FIG. 22 is a block diagram of an example of circuit for inputting a pulsed waveform to the motor.

FIG. 23 is a block diagram of another example of circuit for inputting a pulsed waveform to the motor.

FIG. 24 is an example of control circuit for varying the patting strength.

### DETAILED DESCRIPTION OF THE INVENTION

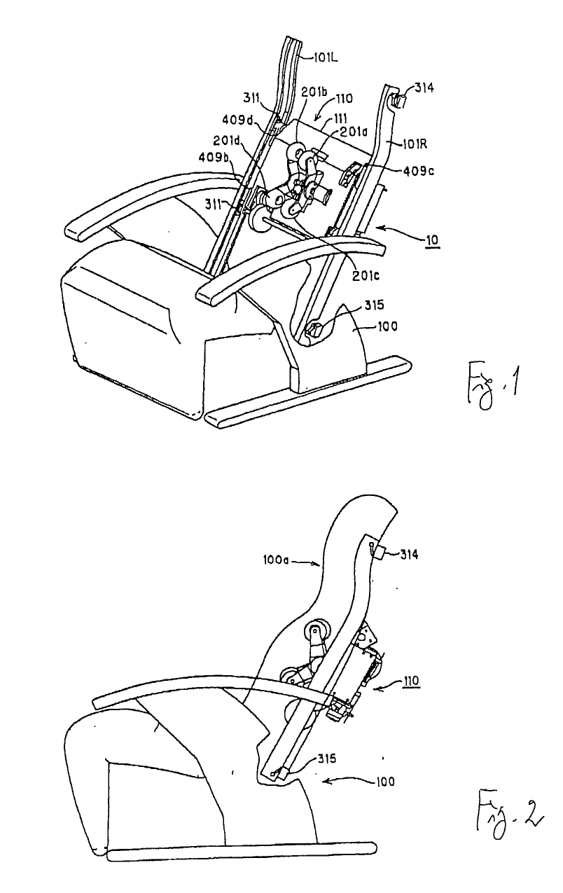

A massaging machine which may be used according to this invention is described first for explaining the mechanical and electrical principles of the method of this invention. FIG. 1 is a diagonal external view of such a massaging machine 10 for schematically showing its structure (the cover sheet and the cushion on the back supporting part 100a being removed). FIG. 2 is its side view with the outer shape and inner structure of its back supporting part 100a being shown.

The massaging machine 10 is basically a reclining chair 100 with the back supporting part 100a incorporating a therapy unit 110 including massaging members 201a-d. The massaging members 201a-d protrude forward from the therapy unit 110 to the front surface of the back supporting part 100a covered by a cover sheet. The massaging members include a first pair 201a and 201b on the right-hand and left-hand sides of the back muscle and a second pair 201c and 201d similarly disposed below the first pair 201a and 201b.

The therapy unit 110 is supported by a pair of cross-sectionally U-shaped guide rails (guiding means) 101R and 101L such that the openings of their U-shapes face each other and adapted to move upward and downward along the guide rails 101R and 101L by the rotary driving motion of pinions 310 which engage with racks inside the guide rails 101R and 101L.

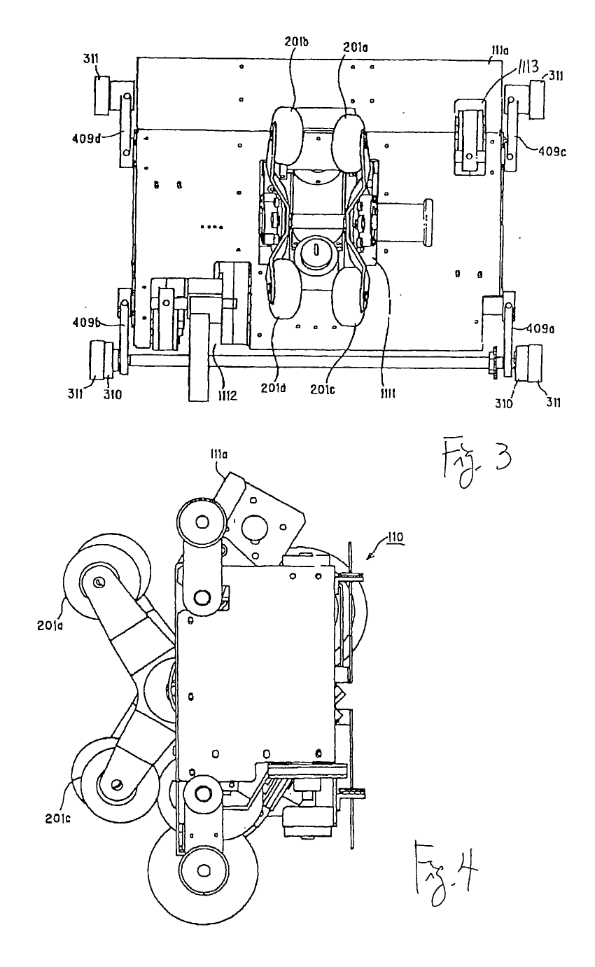

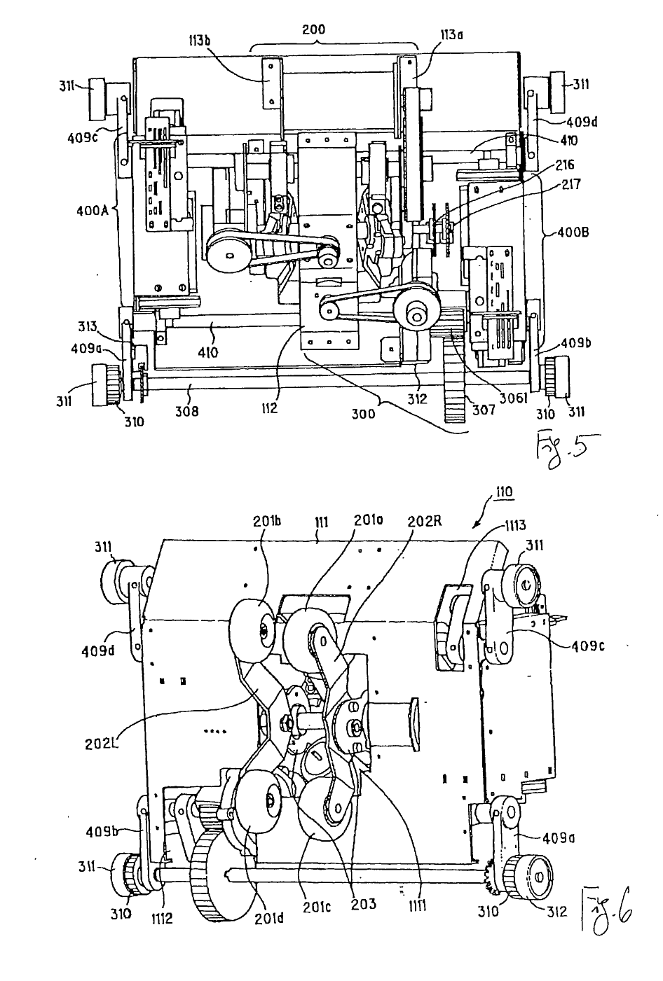

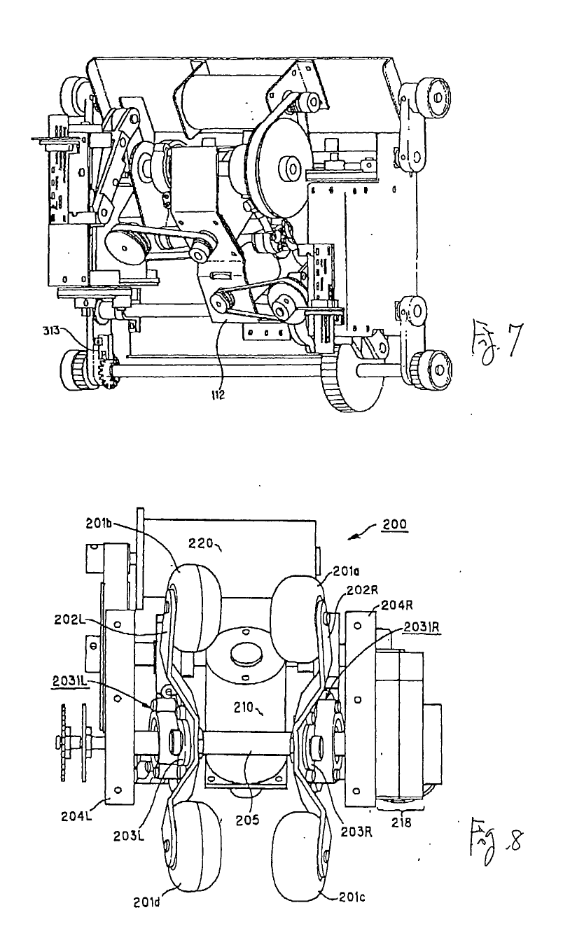

FIG. 3 is a front view of the therapy unit 110, FIG. 4 is its right-hand side view, FIG. 5 is its back view, FIG. 6 is its diagonal frontal view and FIG. 7 is its diagonal back view. The front surface of the therapy unit 110 is covered with a planar base board 111 with its upper end part bent backward and its middle part provided with an approximately rectangular opening 1111 through which the massaging members 201a-d protrude. The base board 111 also includes a removed portion 1112 and an opening 1113 so as to prevent possible interference with moving parts such as a gear.

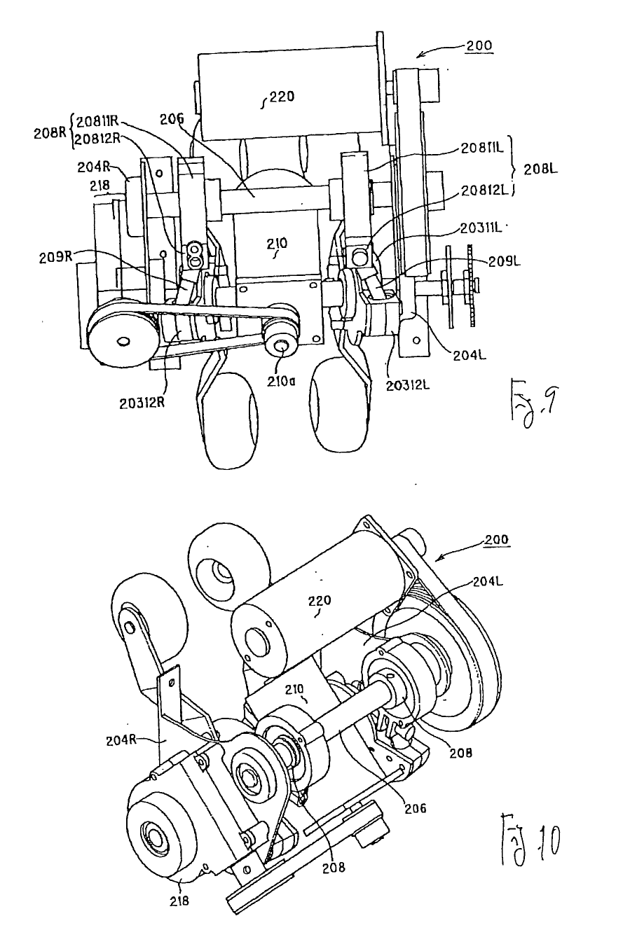

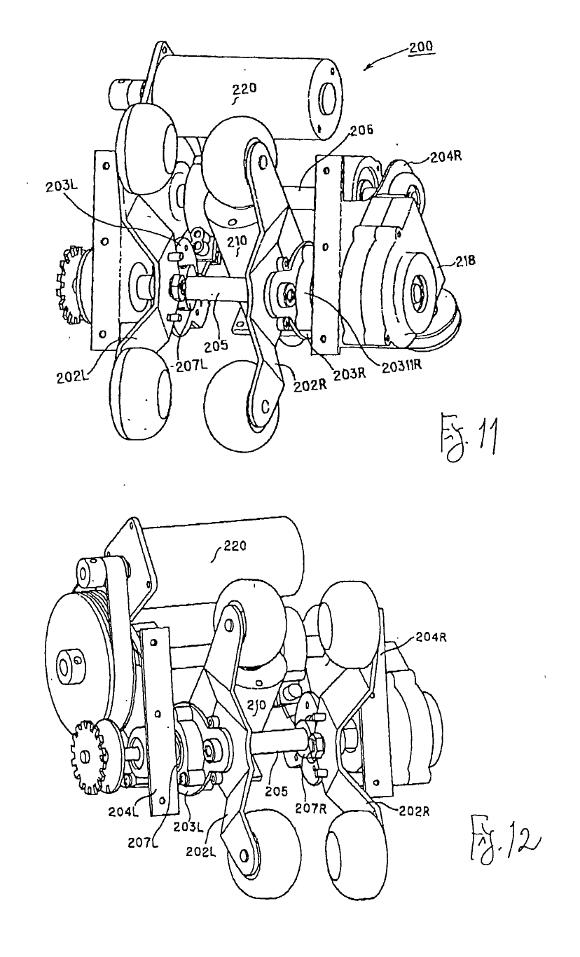

FIG. 8 is a front view of a treatment part 200 attached to the base board 111, FIG. 9 is its back view, FIG. 10 is its diagonal back view taken from an upward position, FIG. 11 is its frontal view taken from its right-hand side, FIG. 12 is its diagonal frontal view taken from the left-hand side, and FIG. 13 is its diagonal back view taken from a lower position. The four massaging members 201a-d are rotatably supported at the tips of approximately V-shaped arms 202R and 202L of which base parts are affixed to arm-supporting members 203R and 203L. These arm-supporting members 203R and 203L are affixed respectively to a side surface of a bearing case 2031 R or 2031 L. These bearing cases 2031 R and 2031 L are rotatably engaged with sloped sleeves 207R and 207L through bearings which rotate along the peripheral surfaces of the sloped sleeves 207R and 207L. The sloped sleeves 207R and 207L are cylindrically shaped and are affixed to a kneading shaft 205 obliquely from both sides with respect to its axial direction so as to slope symmetrically in the left-right direction. The bearing cases 2031R and 2031L are provided not only with a base part 20311R and 20311L for engaging with the outer periphery of corresponding one of the sloped sleeves 207 but also with a link receiving part 20312R or 20312L to which is engaged a spherically formed end of a link 209R or 209L supported so as to swing along the spherical surface.

A patting shaft 206 is disposed parallel to and above the kneading shaft 205. Cylindrical eccentric sleeves 208R and 208L made eccentric in radial direction are affixed to both sides of the patting shaft 206 at positions corresponding to the sloped sleeves 207. The two eccentric sleeves 208 are attached to the patting shaft 206 so as to be eccentric in opposite directions with respect to the patting shaft 206. Bearing cases 2081R and 2081L are rotatably engaged to the outer periphery of the eccentric sleeves 208R and 208L through bearings which rotate along the peripheral surface.

The eccentric sleeves 208 have a base part 20811R and 20811L engaged to the outer periphery and a link receiving part 20812R or 20812L protruding in the peripheral direction. One end of a link 209 (R or L) is connected to the bearing case 2031 (R or L), and the other end of the link 209 (R or L) is supported by the link receiving part 20812 (R or L) so as to swing in the axial direction of the patting shaft 206.

The kneading shaft 205 and the patting shaft 206 are rotatably supported from both sides through bearings by planar holder brackets 204R and 204L affixed to the baseboard 111.

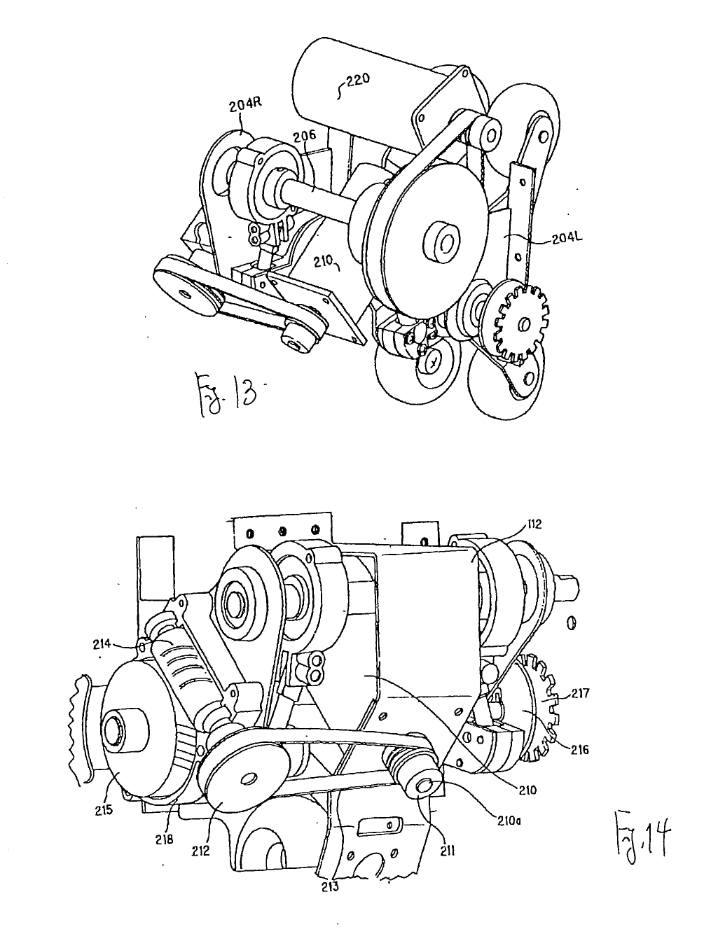

The structure of the kneading mechanism is described next with reference to FIGS. 14 and 15 which are both a back view of the base board 111 with some components removed for the purpose of disclosure. The kneading shaft 205 is operated by a motor 210 affixed to a planar supporting member 112 which is bent more or less into an M-shape, covering the back side of the kneading shaft 205 and the patting shaft 206 and having one end affixed to the backside of the base member 111. A small pulley 211 is affixed to the drive shaft 210a of the motor 210, supporting an endless belt 213 which is wound also around a larger pulley 212 affixed to the shaft of a worm gear 214. The worm gear 214 engages with a worm wheel 215 which is coaxially affixed to the outer circumference of the kneading shaft 205. The worm gear 214 and the worm wheel 215 are rotatably held inside a gear box 218 attached to the holder bracket 204R. Thus, the driving force of the motor 210 is communicated from the small pulley 211 to the endless belt 213 to the larger pulley 212 to the worm gear 214 to the worm wheel 215 while being decelerated, thereby causing the kneading shaft 205 to rotate.

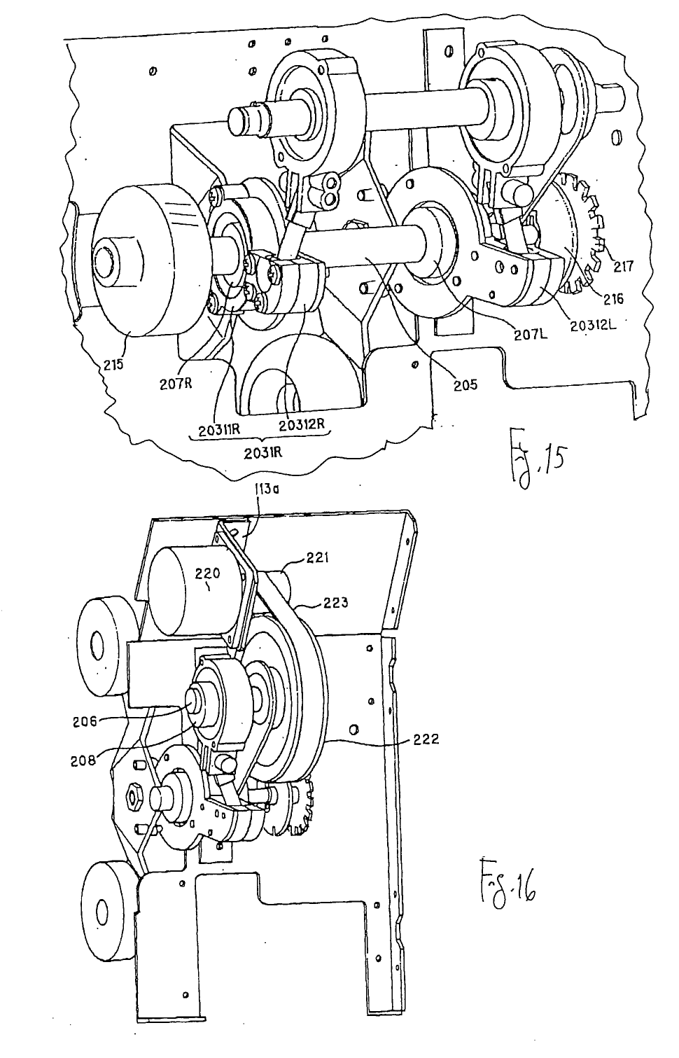

FIGS. 16 and 17 are referenced next to explain the patting operation by the massaging machine structured as explained above. The patting shaft 206 is driven by a motor 220 therefor affixed to the backside of the baseboard 111 through supporting members 113a and 113b as shown in FIG. 5. A small pulley 221 is attached to the drive shaft of the motor 220, and an endless belt 223 is stretched over this small pulley 221 and a large pulley 222 affixed coaxially to the patting shaft 206. Thus, the driving force of the motor 220 is communicated through the small pulley 221, the belt 223 and the patting shaft 206 while being decelerated. Mechanisms for moving the shaft upwards and downwards or forward and backward are not explained although they are provided.

For effecting a patting operation, the rotation of the kneading shaft 205 is stopped while the patting shaft 206 is activated. At this moment, the sloped sleeves 207 are positioned so as to be approximately perpendicular to the kneading shaft 205 of the arms 202R and 202L such that the massaging members are nearly perpendicular to the surface of the back (“zero point of kneading”). A detector plate 216 detecting the zero point of kneading and a kneading position indicator 217 are coaxially affixed to the kneading shaft 205 (as shown in FIG. 14). The zero point detector plate 216 is a disk-shaped member having a slit at one position on its outer periphery such that the zero point of kneading can be detected by means of a photosensor placed behind the base board 111 at a corresponding position so as to sandwich the detector plate 216.

Since the links 209 are supported rotatably through the eccentric sleeves 208 which rotate eccentrically with the rotation of the patting shaft 206, the distance between the axis of rotation of the patting shaft 206 and the link receiving parts 20312R and 20312L engaging the end parts of the patting shaft 206 changes as the patting shaft 206 is rotated. Since the arms 202R and 202L are supported rotatably around the kneading shaft 205, the arms 202R and 202L swing around the kneading shaft 205 to effect the desired patting operation as the motor 220 is operated to rotate the patting shaft 206 at an appropriate speed.

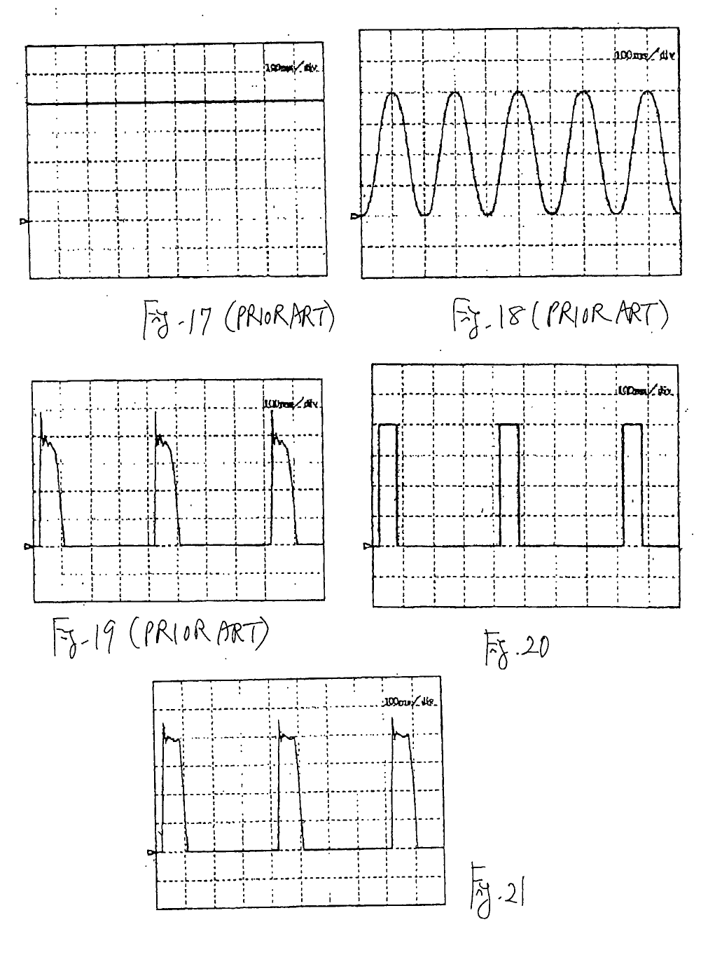

In this operation, if a constant voltage is applied continuously, as shown in FIG. 17, the pressure felt by the patient changes more or less sinusoidally as shown in FIG. 18 because of the aforementioned mechanism for causing the arms 202R and 202L to swing around the kneading shaft 205. In other words, after the pressure by the patting gradually increases, it gradually decreases and this is repeated over and over again. FIG. 18 shows an actually measured pressure change with respect to time, the vertical axis representing the pressure felt by the patient's body. If a masseur pats a patient's body by hand, by contrast, the stimulus waveform is as shown in FIG. 19. This shows clearly that the pressure rises rapidly as the masseur's hand touches the patient's body and after this high-pressure condition is maintained for some length of time, the pressure drops rapidly as the masseur's hand is separated from the patient's body. This is repeated as the masseur repeatedly pats the patient's body and this is what gives a pleasant sensation to the patient.

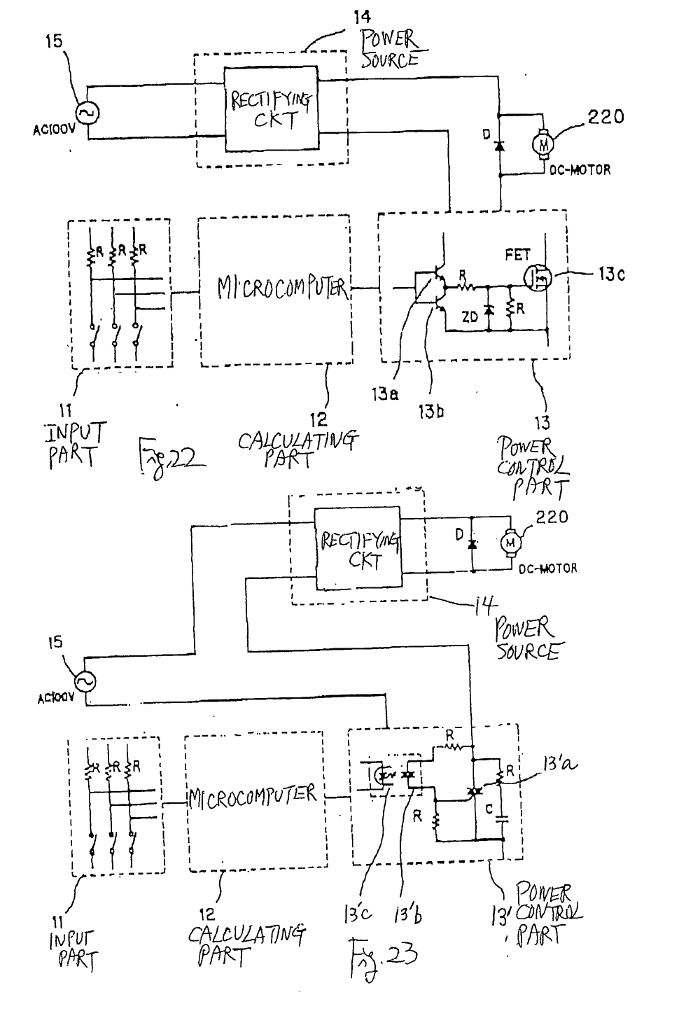

In view of the difference in waveform between FIGS. 18 and 19, it is not a constant voltage that is applied continuously to the motor but a pulsed voltage according to this invention. For example, a pulsed voltage of frequency about 2.5Hz and duty ratio about 20% is applied as shown in FIG. 20. FIG. 21 is a measured pressure change on the patient's body when a pulsed voltage of FIG. 20 was applied to the motor. It clearly shows that the resultant pressure change experienced by the patient is quite similar to that given by a masseur.

Similar experiments were carried out on a plurality of individual patients. As shown in Table 1, while most of the tested individuals (91%) responded that the conventional operating mode hurt them, all of them found the mode according to this invention to be pleasant.

TABLE 1

| | Percentage of | Percentage of patients |
|---|---|---|
| | patients who felt it | who felt it was |
| | hurt | pleasant |
| Conventional method | 91% | 9% |
| Method of this invention | 0% | 100% |

When a pulsed voltage was thus applied, its frequency and duty ratio are important controlling factors. It was discovered that a pulsed voltage with frequency 1-10Hz and duty ratio 2-8.5% is appropriate as shown in Table 2.

TABLE 2

| | Time |
|---|---|
| Time during which the motor is switched on | 0.02-1 sec |
| Time during which the motor is switched off | 0.1-1 sec |

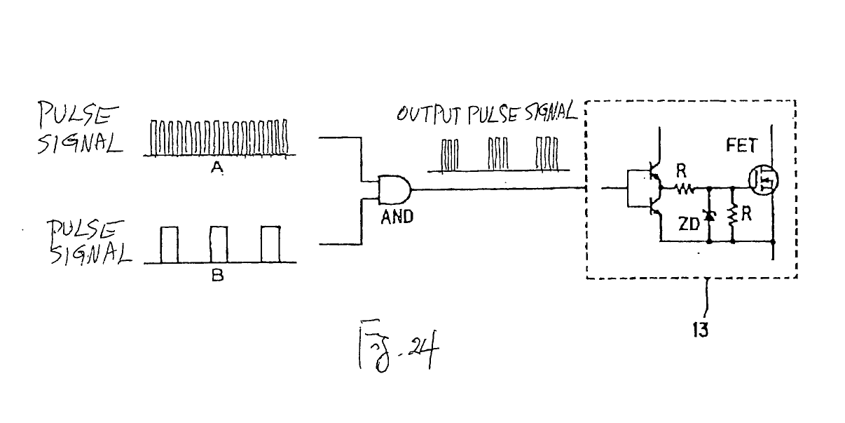

As described above, the present invention is characterized as applying a pulsed voltage to a motor for patting operation in massaging. FIG. 22 shows an example of driving circuit for providing such a voltage to the motor. For generating a pulsed voltage repeatedly outputted at specified intervals, any known pulse control method, pulse width modulation (PWM) method or phase control method may be used. In FIG. 22, numeral 11 indicates an input part comprising switches 11a, 11b and 11c for setting necessary conditions for generating a pulse with desired frequency and duty ratio. Numeral 12 indicates a calculating part which may comprise a microcomputer capable of generating and outputting required control signals from the input from the input part 11. A power control part 13 serves to receive the output from the calculating part 12 and to generate a power control signal for rotating the motor 220 for the patting operation. FIG. 22 shows an example wherein the power control part 13 is formed with two transistors 13a and 13b and a field effect transistor (FET) 13c. Numeral 14 indicates a power source for rectifying power from a commercial source 15 to supply power required by the motor 220.

In order to apply the pulse shown in FIG. 20 to the motor 220, the switches of the input part 11 are operated first to set the frequency and the duty ratio (say, to 2.5Hz and 20%, respectively). The inputted data are transmitted to the calculating part 12 and the calculated result is transmitted to the power control part 13. The rectified voltage from the power source 14 is applied to the motor 220 but the transistors 13a and 13b and the FET 13c of the power control part 13 serve to switch on and off the source according to the output from the calculating part 12 to provide the pulsed voltage to the motor 220.

It now goes without saying that pulse width modulation can also be effected by adjusting the input part 11 in this manner.

Next, an example of phase control method is explained whereby a portion of an AC waveform is cut off to produce a pulse form and it is electrically amplified to rotate a motor. FIG. 23 shows an example of a circuit for driving the motor for patting operation by the phase control method, indicating like parts by the same symbols as in FIG. 22.

With reference now to FIG. 23, the input part 11 allows the user to select whether a phase control should be started at a zero-cross point of a waveform from a commercial power source 15 and stopped at a specified position or it should be started at a specified position and stopped at a zero-cross, as well as a phase angle corresponding to the pulse width. The calculating part 12 comprises a microcomputer capable of generating and outputting required control signals from the input from the input part 11. The power control part 13′ serves to receive the output from the calculating part 12 and to generate a power control signal for rotating the motor 220 for the patting operation. FIG. 23 shows an example wherein the power control part 13′ is formed with a triac 13a′ and a diac 13b′ which is connected to the gate terminal of this triac 13a′ and insulated from a light emitting diode 13c′ by a photocoupler. Numeral 14 again indicates a power source for rectifying power from a commercial source 15 to supply power required by the motor 220.

In order to apply a specified pulse to the motor 220, the switches of the input part 11 are operated first to set the pulse rise position and phase angle with respect to the commercial power source 15 such as 50Hz for frequency of repetition and 20% as duty ratio. The inputted data are used by the calculating part 12 and the calculated result is outputted to the power control part 13′. Voltage from the power source 14 is being applied to the motor 220 but the triac 13a′ and the diac 13b′ of the power control part 13′ serve to switch on and off the current according to the output from the calculating part 12 to apply to the motor 220 a pulsed voltage obtained by cutting off a portion of the sinusoidal waveform of the commercial power source 15.

Although the invention was described above by way of examples but the essence is that a pulsed waveform or a similar waveform with variable frequency, duty ratio, pulse number, pulse width and pulse interval is electrically amplified and applied to the motor for patting operation.

A method of directly controlling the strength of patting is explained next. FIG. 24 shows an example of such method wherein another pulse signal B is superposed to a pulse signal A as shown above such that the width of pulse signal B is changed. For this purpose, a sinusoidal wave or a pulse signal B with higher frequency is generated and a logical product is taken with pulse signal A. The duty ratio of the sinusoidal wave or pulse signal B is changed and the outputted pulsed signal is used to drive the motor 220. This may be considered a kind of PWM method and if the duty ratio of pulse signal B is varied, the effective voltage value applied to the motor changes according to this ratio and a same effect is obtained as if the voltage has been varied or that the strength of the patting operation is varied.

Many modifications and variations of what has been described above are to be considered to be within the scope of this invention. For example, the waveform of the pulse to be applied to the motor 220 may be generated by the microcomputer. The strength of patting may be varied also by changing the voltage of the pulse applied to the motor 220 and thereby changing the rotation of the motor.

By either method, a pulse is modulated by another pulse so as to vary its effective voltage to be applied to the motor 220 such that the strength of patting is varied.

The method of present invention makes it possible to use the mechanism of a conventional massage machine and to give the patient a pleasant sensation of massaging like that by a live masseur, not achieved by prior art massage machines.

What is claimed is:

1. A method of controlling a massaging machine having massaging members and a motor for causing said massaging members to vibrate to massage a patient, said method comprising the step of applying to said motor a driving signal for repetitively switching on and off said motor for specified time lengths whereby said motor is intermittently activated.

2. The method of claim 1 wherein one or more variables of the group consisting of pulse frequency, duty ratio, pulse number, pulse width and pulse interval are changed to vary the frequency by which said massaging members pat the patient.

3. The method of claim 1 wherein an electrical voltage is applied to said motor as said driving signal and wherein said method includes the step of varying said voltage.

4. The method of claim 2 wherein an electrical voltage is applied to said motor as said driving signal and wherein said method includes the step of varying said voltage.

5. The method of claim 1 wherein the strength with which said massaging members pat the patient is varied by carrying out pulse width modulation on the voltage applied to said motor as said driving signal to thereby vary the pulse width of said voltage.
